(19) United States
(12) Patent Application Publication
(10) Pub. No.: US 2007/0032981 A1
(43) Pub. Date: Feb. 8, 2007

(54) Wearable fitness device and fitness device interchangeable with plural wearable articles

(76) Inventors: Carolyn M. Merkel, North Haledon, NJ (US); Barbara J. Merkel, Culver City, CA (US)

Correspondence Address: Ralph J. Crispino, 18 Lake Way, Purdys, NY, 10578, US

(21) Appl. No.: 11/497,572

(22) Filed: Aug. 1, 2006

Related U.S. Application Data
(60) Provisional application No. 60/704,365, filed on Aug. 1, 2005.

(51) Int. Cl. G01C 22/00; G01B 11/02

(52) U.S. Cl. 702/160; 235/105

(57) ABSTRACT

The present invention relates to wearable fitness device and fitness device interchangeable with plural wearable articles. In certain embodiments, the wearable fitness device includes a wearable article having a structure therein or thereon configured and dimensioned for holding a fitness device such as a pedometer in an oriented position. Fashion accessories with functional fitness device are described, thereby allowing one to track their steps while at work, shopping, an evening out, or anytime one is on the move. Further, a fitness device is provided that can capture steps practically and comfortably during a normal person's daily routine.

### RELATED APPLICATIONS

This application claims priority under 35 USC 119 to U.S. Provisional Patent Application No. 60/704,365 filed on Aug. 1, 2005 entitled “Wearable Pedometer Device And Pedometer Device Interchangeable With Plural Wearable Articles”, which is incorporated by reference herein.

### TECHNICAL FIELD

The present invention relates to wearable fitness devices and fitness devices interchangeable with plural wearable articles.

### BACKGROUND ART

Fashion played a vital role in the explosion of fitness accessories and the companies which market them, such as Nike, Adidas, Champion, Reebok, and other companies. This industry has brought the gym out onto the street and into the shopping malls, casual restaurants, schools, etc. However, many people still spend the bulk of their time in places where fitness-oriented clothing, no matter how attractive, is not appropriate or desired. The workplace, places or worship, finer dining establishments, concerts and nightclubs, etc. are all venues where fitness apparel is not usually worn. People who spend the majority of their hours outside of the gym are looking for solutions to the problem of building fitness into their lives.

Meanwhile, affordable and attractive fashions and fashion accessories continue to serve busy people's lives. With disposable income higher than disposable time, people look to manufacturers to provide functional attractive solutions. The market for fashion accessories continues to grow.

Certain people attempt to incorporate fitness into their everyday lives. For example, we all know that we should walk more, but tracking our progress has been limited by ugly, impractical step meters. For women and certain workers required to wear uniforms, existing step counters are impractical. Existing counters typically are clipped to the waistband of the wearer's clothing, or alternatively may be strapped to the waist using a band. While this method of attachment is practical when the wearer is dressed in athletic clothing such as jogging pants, shorts or sweat pants, it is impractical and cumbersome when the wearer is dressed in less casual clothing such as a dress, suit or uniform. Many articles of clothing, e.g., dresses, offer no waistband on which the device can be attached, while other articles of clothing, e.g., skirts or dress pants, develop awkward and uncomfortable bulges when the device is attached. For workers in uniform, e.g., wait staff, nurses, etc., attachable devices are outside of the safe or desired dress code. In all circumstances, the clip may be dislodged resulting in loss of the device during normal daily activities such as working, driving, cleaning, using the toilet, etc.

Recent medical research¹ confirms that calories expended outside of planned exercise are critical to maintaining or losing weight. It is generally agreed² that the best way for a sedentary (or active) person to increase the amount of calories expended is by simply walking. The government³ recommends that the general public strive to add extra steps of walking to their daily regimen every day, and to use a step counter or pedometer to measure progress to the attainment of the goal. None-the-less, for many people the inability to accurately capture non-planned exercise
¹ http://www.mayoclinic.org/news2004-mchi/2310.html

² See, e.g., http://www.americaonthemove.org, http://aom.americaonthemove.org/site/c.hiJRK0PFJpH/b.1311167/k.8725/active_living.htm

³ CDC, e.g., Wilson D B, Porter J S, Parker G, Smith T J, Kilpatrick J. Using exercise for risk reduction in African American breast cancer survivors: a community-based pilot study [abstract] Prev Chronic Dis [serial online] 2004 Apr [date cited]. Available from: URL: http://www.cdc.gov/pcd/issues/2004/apr/03_{—}0034r.htm.; NIH, e.g., http://dnrc.nih.gov/move/pedometer_use.htm steps due to the impracticality of the pedometers available results in frustration, so that the programs goals are not achieved.

Various types of pedometers are known. In general, most pedometers count steps taken due to the impact of every forward or downward movement, which causes a hammer to hit a sensor which activates a counter. Certain pedometers have various sensitivity adjustments to fit individual needs. Some pedometers take the number of steps counted and convert them into a distance. Most pedometers have a tiny spring-set horizontal arm that moves up and down as you walk and measures the vertical movement, e.g., of your legs. Electronic pedometers can detect the impact of your foot hitting the ground. Discussions of pedometers can be found, for example, at WellSpring, “Watch Your Step: Pedometers and Physical Activity”, Winter 2003 Volume 14, Number 2 by Marshall et al.⁴ and Detroit Free Press Business News, “Consumer guide: Pedometers”, May 4, 2003 by Barbara Arrigo⁵.
⁴ http:www.centre4activeliving.ca/publications/wellspring/2003/Spring/HowTheyWork.html

⁵ http://www.freep.com/money/business/guide4_{—}20030504.htm; http://www.jsonline.com/story/index.aspx?id=144671 (Jun. 1, 2003 editions of the Milwaukee Journal Sentinel)

In addition, accelerometers have been taught as having application in pedometers. For example, U.S. Pat. No. 7,008,350 to Yamazaki , et al. issued Mar. 7, 2006 entitled “Health amount-of-exercise managing device” teaches an apparatus for managing the quantity of exercising to be healthy, using a body fat meter along with a pedometer or an accelerometer for measuring vertical shaky movement; U.S. Pat. No. 6,898,550 to Blackadar, et al. issued May 24, 2005 entitled “Monitoring activity of a user in locomotion on foot” discloses a foot mounted sensor for sensing motion of one's feet such as a solid-state accelerometer that senses acceleration along an acceleration sensing axis; and U.S. Pat. No. 6,298,314 to Blackadar , et al. issued Oct. 2, 2001 entitled “Detecting the starting and stopping of movement of a person on foot” also discloses an accelerometer is mounted on a person's foot so that it generates a signal when the person's foot moves. These various devices advantageously utilize multiple functions of motion-sensing chip technology to incorporate various functionality into the device.

In addition to the functional changes required to ensure that the pedometer or accelerometer accurately records the number of steps, it is also desired that the device fit into the wardrobe of the wearer. This may be accomplished by various embodiments of the present invention, integrating functionality and fashion to enhance the success of a wearer using the product and following the guidelines for healthy living as medical experts recommend. While the benefits of pedometers and the like are well known, heretofore unknown to the art are integrated fashionable accessories and garments suitable for holding pedometers and/or other fitness devices.

### BRIEF SUMMARY OF THE INVENTION

Therefore, it is an object of the invention to provide desirable fashion accessories with functional fitness devices, such as pedometers or accelerometers, thereby allowing one to track their steps while at work, shopping, an evening out, or anytime one is on the move.

The present invention relates to wearable fitness device and fitness device interchangeable with plural wearable articles.

In certain embodiments, the wearable fitness device includes a wearable article having a structure therein or thereon configured and dimensioned for holding a fitness device such as a pedometer in an oriented position.

Fashion accessories with functional fitness device are described, thereby allowing one to track their steps while at work, shopping, an evening out, or anytime one is on the move. Further, a fitness device is provided that can capture steps practically and comfortably during a normal person's daily routine.

### BRIEF DESCRIPTION OF THE FIGURES

The foregoing summary as well as the following detailed description of preferred embodiments of the invention will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings, where:

FIG. 1 shows a general embodiment of a system of the present invention wherein a fitness device may be interchangeable between multiple types of wearable articles;

FIGS. 2A and 2B shows an embodiment of a wearable article for positioning and orienting a fitness device;

FIG. 3 shows an exemplary pocket with a securing strap for holding a fitness device;

FIGS. 4A-4C show exemplary structures for positioning and orienting a fitness device on a wearable article;

FIG. 5 shows an exemplary system for properly aligning a fitness device on a wearable article; and

FIG. 6 shows an exemplary embodiment of a fitness device including an added degree of comfort provided by matching the shape of a wearer's body or leg.

### DETAILED DESCRIPTION OF THE FIGURES

Provided herein is a fitness accessory in the form of a wearable article of clothing and a fitness device attached to the wearable article of clothing. In certain embodiments, a fitness accessory in the form of a wearable article of clothing includes a device requiring accurate positioning and orientation such as a pedometer.

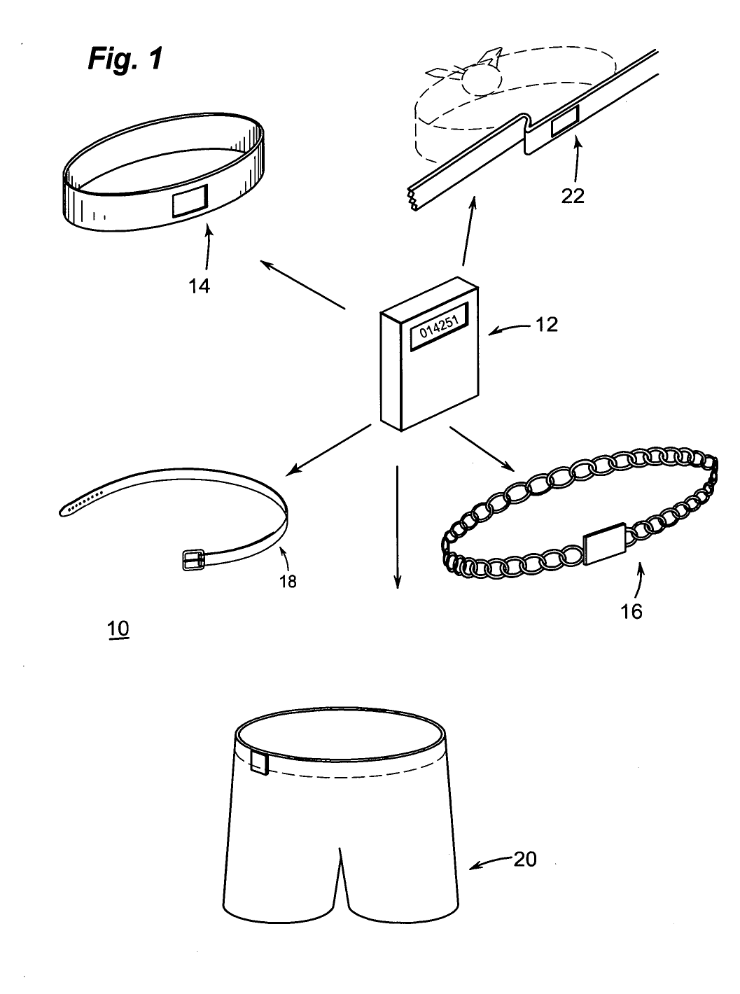

Referring to FIG. 1, a general system 10 of the present invention is shown, wherein a fitness device 12, the fitness device including those used to measure one's distance traversed such as a pedometer (e.g., a mechanical pedometer, an electro-mechanical pedometer, an electronic pedometer) or an accelerometer, is depicted as being associated with plural types of articles of clothing or fashion accessories. For example, anklets 14 and 16, belt 18, shorts 20, or a bandanna 22 (or other type of garment suitable for tying around one's body or limb, e.g., armband) may be interchangeable with a fitness device 12 in the system or kit 10 according to certain aspects of the present invention. Note that additionally, the fitness device 12 may be interchangeable with other wearable articles, for example, of the same type (e.g., anklets, shorts, bandana, armband, belt, etc.) of different style or color, for example, to coordinate with different color outfits and/or accessories.

As shown, the belt 18 has an extended shape configured to fit within a buckle, and associated holes as in conventional belts. In certain preferred embodiments, the belt 18 is an adjustable band. A suitable holding structure is included for holding the fitness device 12. Alternatively, the belt 18 could use a hook and loop fastening system, one or more buttons, snap-fit fasteners, a peg and hole mechanism, chain links, elastic materials, or any other suitable fastening system.

Anklet 14 is configured, e.g., as a slide-on type anklet. Preferably, the anklet is formed of a suitable shape and material for a core that maintains its position upon one's body. A suitable holding structure is included for holding the fitness device 12. Preferably, such an anklet 14 or a core thereof is formed of a suitable elastic material such as spandex fiber, knitted elastics, net elastics, rubber-based articles or stretchable cloth. Further, the anklet 14 may be formed of a suitable elastic configuration, such as a loose cloth encompassing an elastic strap as the core. Alternatively, the anklet 14 may include a suitable spring as the core. Such material desirably provides a suitably snug fit to prevent the anklet from sliding out of position, while not being excessively tight to harm the wearer, e.g., in the form of reduced blood circulation or irritation.

Anklet 16 is in the form, e.g., of a chain link anklet. A suitable holding structure is included for holding the fitness device 12. Connections between the fitness device 12 and the anklet 16 include, for example, suitable clasps (e.g., lobster claw clasps) on each end of an anklet, with connector rings attached to each side of the fitness device 12.

Other types of anklets, armbands, belts or other wearable articles may also be used and integrated with the system 10, including those secured in place using an adjustable band. Suitable adjustable bands include those with a buckle and associated holes, a hook and loop fastening system, one or more buttons, snap-fit fasteners, a peg and hole mechanism, chain links, or any other suitable fastening system. The article of clothing may include anklets, belts, pants/shorts, as shown with respect to FIG. 1, or shirts/blouses, undergarments, shoes, or other articles of clothing.

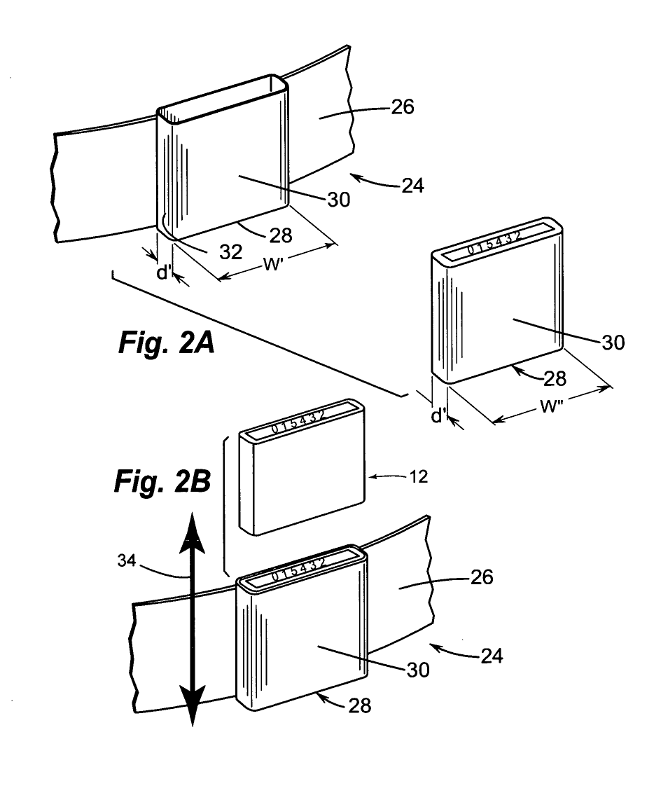

Referring to FIG. 2A, a wearable article 24 includes a fitness device 12 associated therewith. In general, the wearable article 24 includes a strap 26, e.g., forming the body of the article 24. The strap 26 can secure the article 24 around a person's ankle, leg, or waist, or wrist. In certain embodiments, the article 24 incorporates the fitness device 12 in accurate positioning and orientation to function effectively.

In the example of FIG. 2A, the article 24 includes a pocket or holding structure 28 permanently or removably attached thereto. The pocket is generally characterized by a front panel 30 width w′ and a sidewall 32 giving the pocket 28 a depth d′. In certain preferred embodiments, the fitness device 12 has correspondingly similar width w″ and depth d″ so that the fitness device 12 may be securely held within the pocket 28. FIG. 2B shows the fitness device 12 being inserted 34 within the pocket 28 of the wearable article 24.

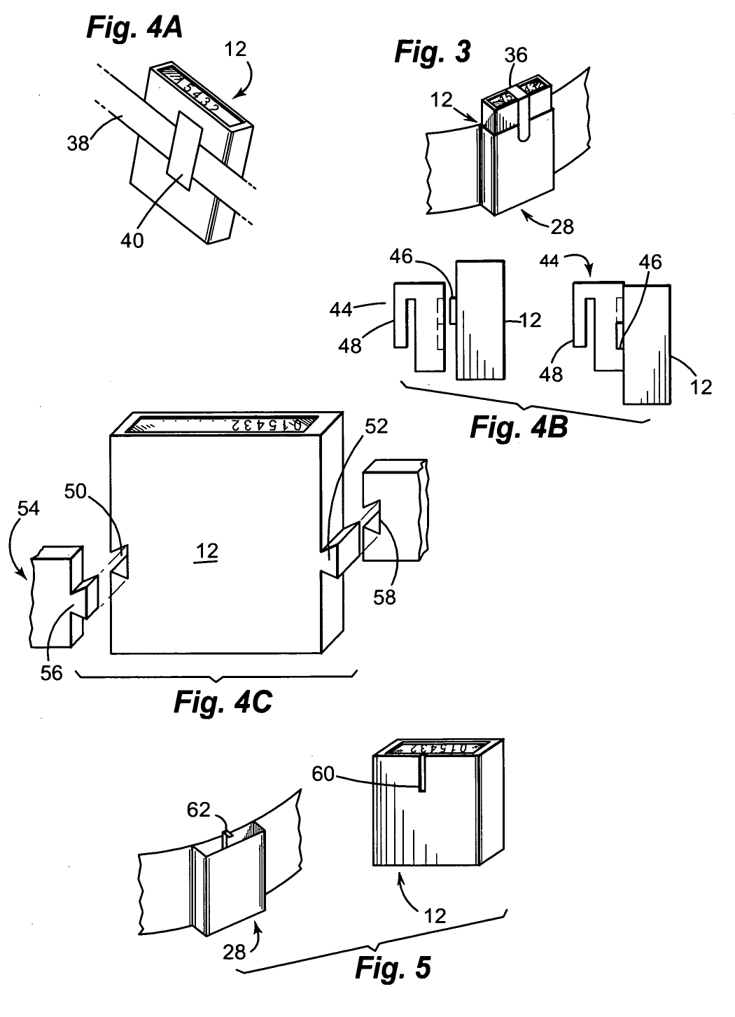

Referring now to FIG. 3, a fitness device 12 is shown within a pocket 28 further including a securing strap 36. The securing strap 36 serves to hold the fitness device 12 in position, prevent accidental removal of the fitness device 12, provide orienting functionality, or a combination of the above features. The securing strap 36 may attach to the front panel of the pocket 28 as shown, or alternatively attach to another suitable location. The securing strap 36 may secure to the front panel or other suitable location by any type of removable attachment including but not limited to a hook and loop fastening system, a buckle, one or more buttons, snap-fit fasteners, a peg and hole mechanism, chain links, or any other suitable fastening system. Further, the strap may be formed of a flexible material such as cloth, webbing, leather, natural fibers, flexible plastic, or other suitable material. Alternatively may be formed of a rigid or semi-rigid material with a suitable hinge structure.

The fitness device 12 may be attached to the wearable article with a variety of structures. Preferably, in the case of certain pedometers as the fitness device 12, the structures allow the fitness device 12 to be maintained in a proper position on one's body to accurately measure ones' walking and/or running steps. For example, pedometers requiring maintenance of proper orientation during use to accurately measure one's steps desirably are attached to the wearable article in a manner that facilitates such proper orientation.

Referring to FIG. 4A, the fitness device 12 may be attached to an article or portion of an article 38 by threading the elongated article 38 through a loop 40.

Referring to FIG. 4B, the fitness device 12 may be attached to a clip structure 44. Clip structure 44 is configured for holding the fitness device 12. As shown, the clip structure 44 includes a receiving portion corresponding to a suitable protrusion 46 of the fitness device 12. The clip structure 44 further includes a suitable structure 48 for attaching to an article of clothing on one's body, e.g., a slide clip structure. Alternatively, the clip 44 may include a protrusion associated with a suitable receiving portion on the fitness device 12. Other removable attachment structures may be used to attach the fitness device 12 to the clip structure 44.

Referring now to FIG. 4C, another example of a suitable removably connected configuration for holding the fitness device 12 in place is shown. The fitness device 12 includes suitable features 50, 52 corresponding to mating features 56, 58 on a wearable article 54 (or a portion thereof). While the removably connected configuration is shown as having male portion 56 of article 54 secured to female portion 50 of fitness device 12, and as having female portion 58 of article 54 secured to male portion 52 of fitness device 12, it will be appreciated that other configurations are possible. The features 50, 52, 56, 58 may be snap fit, friction fit, or other suitable removable connection structures. A key benefit of the system of FIG. 4C is that it per se provides a one-way connection between the fashion portion and the fitness device, which allows for only possible orientation upon attachment.

Referring now to FIG. 5, an example of an orienting feature is shown. Fitness device 12 includes an alignment mark 60. A pocket 28 (or other suitable holder) includes a corresponding alignment mark 62. Preferably, the alignment marks are in such a position to minimize or eliminate improper orientation of the fitness device.

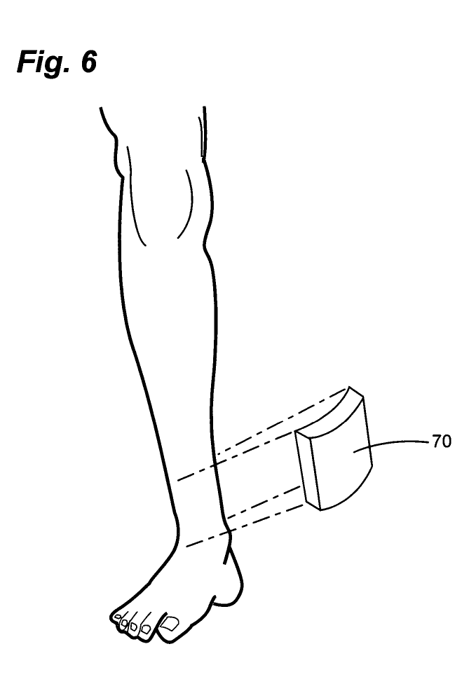

Referring now to FIG. 6, another feature of the present invention is provided to enhance comfort. A fitness device 70 is provided having suitable curvature, e.g., of molded plastic, to fit comfortably against one's body. The curvature can be any suitable shape of curvature and degree of curvature, depending upon the device and the location at which it will be attached to the body, e.g, leg, arm, neck, torso.

As used herein, the term “fitness device” may refer to any suitable device for assisting in one's maintenance of personal fitness. The fitness device may include devices used to measure one's distance traversed, such as pedometers or accelerometers, heart rate monitors, blood pressure monitors, or any such device which measures or records static or active body parameters. In certain preferred embodiments herein, the fitness devices include those used to measure one's distance traversed is a pedometer such as a mechanical pedometer, an electro-mechanical pedometer, an electronic pedometer, or an accelerometer.

Although most known pedometers require proper orientation during use, it is to be understood that the present invention contemplates pedometers and/or accelerometers touted as functioning regardless of orientation, such as a vibration-detecting pedometer, such as the device disclosed in U.S. Pat. No. 6,836,524 to Lee issued on Dec. 28, 2004 entitled “Pedometer for detecting vibrations in the motion direction”.

Further, accelerometers may be desired for incorporation into a wearable article due to their small size, and in certain embodiments, lack of requirement for orientation, to allow for a simpler and more aesthetically pleasing device. For example, one suitable accelerometer may include Mesmic, Inc. model MXC6202G/H/M/N (North Andover, Mass.) (e.g., as described in the specification sheet Rev.B dated Nov. 10, 2005). Further, a small compact accelerometer used to measure one's distance traversed can readily be attached and removed from one style or type of wearable article to another.

In particular, certain solid-state accelerometers are desirable, such as those that that senses acceleration along an acceleration sensing axis. Certain accelerometers employ a strain gauge for detecting the displacement of the weight supported by a spring. Alternatively, a piezoelectric element may be used in place of the spring, which piezoelectric element can measure the acceleration in terms of the electricity, which appears across the element in proportion to the displacement of the weight. In further alternatives, a suitable accelerometer uses a coil-and-weight in a magnetic field for inducing electromotive force in the coil moving in the magnetic field, thereby measuring acceleration in terms of the induced electromotive force.

Various types of displays are available on existing distance measuring devices such as pedometers or accelerometers, including mechanical or electronic displays. In certain preferred embodiments, for convenience of tabulation of distance traversed, a display may comprise a series of small lights (e.g., LED or LCD) that light up as desired intervals are achieved. For example, to correspond to the recommended 10,000 steps per day, five lights may be provided, whereby each indicated a 2000 step interval. This will enhance the aesthetic appeal of the device and minimize intrusion due to extended readouts and the like. Further, a device may also be programmed to read out a pattern of interim light sequences to indicate to the user their progressing within each 2000 step interval.

As described herein, in certain embodiments, a fitness device such as a pedometer may require accuracy of position within a zone of the body. As an example, if the device is a mechanical or electro-mechanical pedometer used as an anklet, the pedometer is preferably to be positioned and remain on the front side of the ankle so as to cause the mechanical device to record each leg movement. For example, accuracy is maintained in the system herein using the elastic or adjustable band to hold the wearable article incorporating the fitness device in place.

Further, as described herein, the fitness device, such as a pedometer, typically requires accuracy of orientation during wear. Orientation must be correct when the wearer puts the fashion device on. Various pockets, clip structures, securing structures, and the like are described herein. In certain preferred embodiments, these various pockets, clip structures, securing structures, and the like provide one-way connections between the fashion portion and fitness device. Further, alignment marks are also described above for ensuring proper orientation.

Additionally, various embodiments hereof enhance comfort. Comfort is desired to allow the wearer to use the fitness device more frequently, even during all waking hours of the day. As described above, the fitness device (e.g., pedometer, accelerometer) may be formed in a suitable housing curved appropriately to fit comfortably against the body. Further, the wearable article may include a suitable core that flexes to allow for comfortable movement of the wearer. Flexibility may be achieved by elastic, springs, or other such flexible materials or configurations.

Finally, a key feature of the present invention is its fashion flexibility. Certain embodiments describe systems that allow one fitness device to be interchangeable with plural wearable articles. This allows one to conveniently and fashionably use of the fitness device during different parts of the day. This is accomplished, e.g., with the interchangeable fitness device with multiple fashion portions, so that the fitness device can be changed between from one fashion type to another during the course of the wearer's day, allowing the wearer to measure a complete day of data on a single fitness device. This option would work well for wearers who switch outfits during the day. For example, business clothes during the day for work, casual clothes in the afternoon for home and dress clothes for evening. Additionally, the option of designs suitable for clubs, corporations, political activities, etc., such as used in marketing materials, are readily incorporated into this device.

While preferred embodiments have been shown and described, various modifications and substitutions may be made thereto without departing from the spirit and scope of the invention. Accordingly, it is to be understood that the present invention has been described by way of illustrations and not limitation.

1. A fitness accessory kit comprising:
the wearable article as in claim 6 and at least a second wearable article;
wherein the fitness device may be removed from the wearable article and removably secured to the second wearable article.

2. A fitness accessory kit comprising:
at least a first and a second wearable article; and
a fitness device interchangeably connected between the first wearable article and the second wearable article.

3. A fitness accessory as in claim 6,
the fitness device being removably secured to the wearable article with a pocket to maintain the fitness device in proper orientation during use.

4. (canceled)

5. (canceled)

6. A fitness accessory comprising:
a wearable article; and
a fitness device removably secured to the wearable article.

7. The accessory as in claim 6, wherein the fitness device comprises a pedometer.

8. The accessory as in claim 7, wherein the pedometer comprises a mechanical pedometer, an electro-mechanical pedometer, or an electronic pedometer.

9. The accessory as in claim 6, wherein the fitness device comprises an accelerometer.

10. The accessory as in claim 9, wherein the accelerometer comprise a solid state accelerometer.

11. The accessory as in claim 6, wherein the wearable article is selected from the group consisting of anklets, belts, pants/shorts, shits/blouses, undergarments, armbands, and shoes.

12. The accessory as in claim 6, wherein the wearable article is one or more anklets and the fitness device is a pedometer or an accelerometer.

13. The kit as in claim 1, wherein the plural wearable articles comprise plural types of wearable articles.

14. The kit as in claim 1, wherein the plural wearable articles comprise plural styles or colors of one type of wearable articles.

15. The kit as in claim 1, wherein the plural wearable articles comprise plural types of wearable articles and at least two of one type of wearable article, said at least two of one type of wearable article comprises plural styles or colors of at least one of the plural types of wearable articles.

16. The kit as in claim 2, wherein the fitness device comprises a pedometer.

17. The kit as in claim 16, wherein the pedometer comprises a mechanical pedometer, an electro-mechanical pedometer, or an electronic pedometer.

18. The kit as in claim 2, wherein the fitness device comprises an accelerometer.

19. The kit as in claim 18, wherein the accelerometer comprise a solid state accelerometer.

20. The kit as in claim 2, wherein the wearable article is selected from the group consisting of anklets, belts, pants/shorts, shirts/blouses, undergarments, armbands, and shoes.

21. The kit as in claim 2, wherein the wearable article is one or more anklets and the fitness device is a pedometer or an accelerometer.

22. The kit as in claim 2, wherein the plural wearable articles comprise plural types of wearable articles.

23. The kit as in claim 2, wherein the plural wearable articles comprise plural styles or colors of one type of wearable articles.

24. The kit as in claim 2, wherein the plural wearable articles comprise plural types of wearable articles and at least two of one type of wearable article, said at least two of one type of wearable article comprises plural styles or colors of at least one of the plural types of wearable articles.
